(19) United States
(12) Patent Application Publication
(10) Pub. No.: US 2008/0149615 A1
(43) Pub. Date: Jun. 26, 2008

(54) Inclined heating element

(76) Inventor: Frank Anthony Agnello, South Elgin, IL (US)

Correspondence Address: LADAS & PARRY LLP, 224 SOUTH MICHIGAN AVENUE, SUITE 1600, CHICAGO, IL, 60604, US

(21) Appl. No.: 11/590,089

(22) Filed: Oct. 31, 2006

(51) Int. Cl. F27B 9/06

(52) U.S. Cl. 219/388

(57) ABSTRACT

A heating element that extends upwardly from a horizontal surface at an angle, can be used to evenly heat foodstuffs having inclined surfaces. The heating element can be flat or curved to be convex or concave.

### BACKGROUND

Restaurants and food service providers that provide unusual or unique foodstuffs often have a competitive advantage over business that do not otherwise distinguish themselves. Because most restaurants and food service providers cook or heat foodstuffs for consumption before they are sold or served to a customer, the ability to quickly and properly heat or cook a unique food item can be important to the success of a food service business.

A “pizza cone” is a relatively unique food item and as the term is used herein, “pizza cone” refers to an edible cone, the interior of which is filled with pizza fillings, such as meats, cheeses and other ingredients. The cone portion of a pizza cone is usually made from pizza dough, however, pizza cones made from other types of dough can also be filled with pizza fillings or other foods.

Because of its shape, a pizza cone is particularly difficult to heat and/or cook. If the cone is place on its “side” for cooking, fillings inside the cone will spill or fall out of the cone as temperature rises. If the cone were to be inverted so that the open end is downward, and then placed on a flat surface for heating, the contents would either leak out during heating or spill when the cone turned upright.

One way to heat a cone is to heat it while it is upright, i.e., with the pointed, narrow end of the cone downward, in order to keep fillings in the cone as it the cone is heated.

A problem with heating and/or cooking edible cones is that their conical shape makes it difficult to evenly heat a cone from top to bottom. A cone is also difficult to heat around its perimeter. A heating element, which could be used with or without an oven enclosure to uniformly heat a cone from top to bottom would be an improvement over the prior art.

### BRIEF DESCRIPTION OF THE DRAWINGS

FIG. 1 shows a front elevation view of an oven for baking cones and cone-shaped foods;

FIG. 2 shows a perspective view of the front side of an oven showing a horizontal carousel conveyor that carries cone-shaped foodstuffs past an inclined heating element shown in phantom lines.

FIG. 3 shows an inclined heating element and its location in an oven.

### DETAILED DESCRIPTION

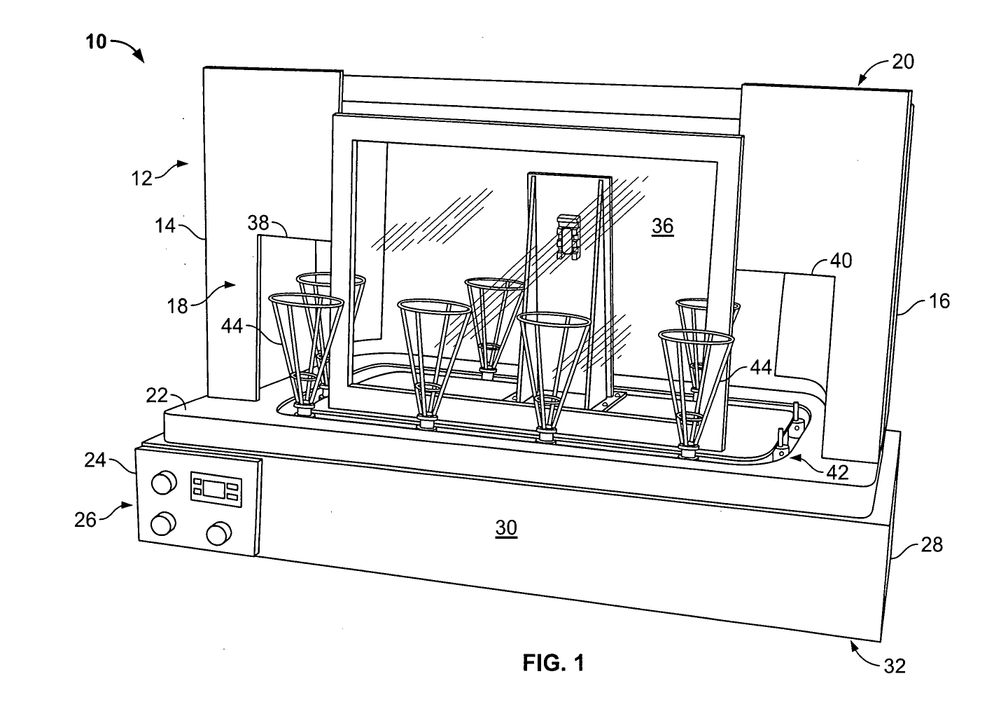

FIG. 1 shows a rectangular-shaped oven 10 particularly suited for baking cone-shaped dough and/or batter in order to cook cone-shaped foodstuffs such as pizza cones and ice cream cones.

As best seen in FIG. 1, the oven 10 has an upper housing or box 12 having four sides, (left 14, right 16, front 18, and rear, not shown) and a top 20. The sides and top are insulated to keep heat within the oven's interior and to keep the exterior surfaces of the sides and top cool to the touch.

The upper housing 12 is attached to the top surface 22 of a base unit 24. In one embodiment, the upper housing 12 is attached to the base unit 24 by a hinge that is attached to the base unit 24 along the top rear edge (not shown) of the base unit 24 and the lower rear edge of the upper housing 12. The hinge between the upper housing 12 and the base unit 24 allows the upper housing 12 to be pivoted upwardly in order to provide access to the interior of the oven 10.

In the embodiment of the oven 10 shown in FIG. 1, the front side 18 of the upper housing 12 is provided with a viewing window 36 by which an operator can view the cooking progress of cones or other food stuffs passing through the oven 10. The viewing window 36 is preferably made from a translucent, heat-tolerant glass or other translucent heat-tolerant material, such as quartz.

Importantly, the front side 18 of the upper housing 12 is provided with two passage ways or openings 38 and 40. The openings 38 and 40 are spaced apart from each other in the front side 18 so as to be located proximate to the left-hand side 14 and the right hand side 16 respectively.

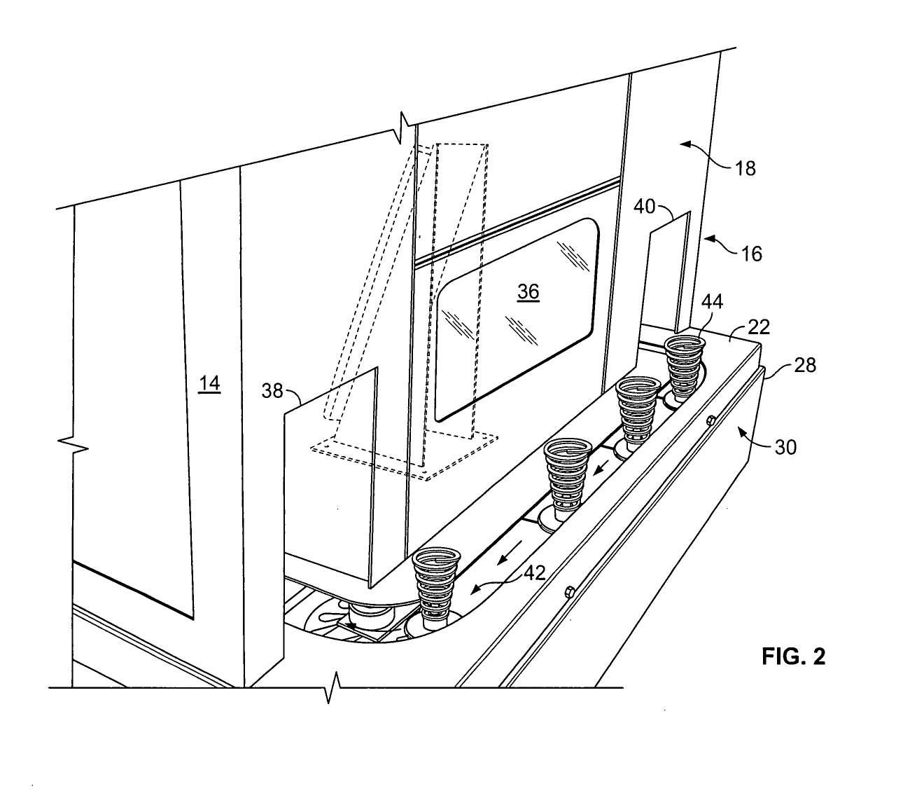

A motor-driven, variable speed conveyor mechanism enclosed in the base unit 24 provides a closed-loop, horizontal carousel conveyor 42 (hereafter conveyor 42) by which heating stations 44 attached to the conveyor are carried through the oven 10 in order to cook foodstuffs in or on a heating station. As shown, the heating stations 44 are vertically-oriented and sized, shaped and arranged to hold cone-shaped items upright, i.e., with the narrow, pointed end downwardly. The heating stations 44 pass into the oven 10 through a first one of the openings (38 or 40) and out from the oven through the other opening (34 or 32). As can be seen in FIGS. 1, 2 and 4, the several heating stations 44 attached to the conveyor 42 travel in the same, substantially-horizontal geometric plane, which can be considered to be the top surface 22 of the oven bottom 24.

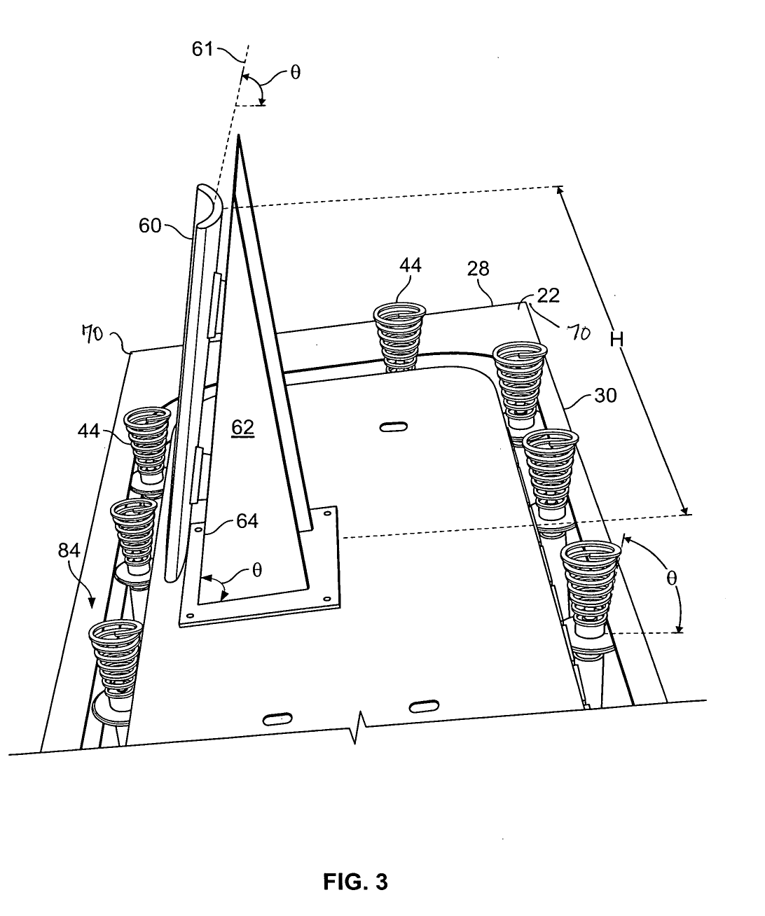

Referring now to FIG. 3, this figure shows a perspective view of the interior of the oven 10 but with the upper housing 12 detached and removed. A substantially rectangular but also concave heat-emitting device 60 is attached to a triangular sheet metal heater support bracket 62. As can be seen in the figure, the heat emitting device 60, which can also be referred to as a heater or heating element, has a vertical dimension or height H, and a longitudinal axis 61 at the center of the curved heating element. The longitudinal axis extends upwardly from the top surface 22, which can be considered a horizontal plane, at an angle θ. The angle θ is substantially equal to an angle formed by a surface of foodstuff to be cooked or heated by heat emitted from the heater element 60, examples of which include pizza cones, ice cream cones or other foodstuffs having surfaces that are inclined.

In the embodiment shown in FIG. 3, the heater element 60 depicted in the figure and encompassed by the claims is curved so as to be concave with respect to the heating stations 42. A concave heat-emitting surface or heater element will tend to direct heat around at least part of a cone-shaped foodstuff by the heat energy emitted from the surface area of the concave heater element 60 that is away from its central axis, i.e., near the outer edges of the element 60.

In alternate embodiments, which are also considered to be within the scope of the appurtenant claims, the heater element 60 can be flat or planar, or convex. Two or more heater elements 60 could also be placed on both sides of the conveyor so that heat from their inclined surfaces reaches opposite sides of a cone-shaped food stuff. Multiple heater elements 60 could also be staggered along the conveyor line as well as being placed opposite to each other.

While the heater element 60 shown in the figure is substantially rectangular, i.e., having a height greater than its width, alternate embodiments of the heater element contemplated by the inventor and considered to be encompassed by the appurtenant claims include heater elements that are square, rectangular, triangular or even round.

In one embodiment, the heater element 60 was heated by the combustion of natural gas although liquid propane or LP would work equally well. In such an embodiment, the heater element 60 is considered to be a gas burner.

In an alternate embodiment, the heater element 60 can be an electrically resistive element. In such an embodiment, the heater element 60 is considered to be an electric burner. Those of ordinary skill in the art will recognize that the heater element 60 could be a hybrid of both an electric heating element and a gas burner.

Still referring to FIG. 3, it can be seen that the heater support bracket 62 is attached to the top surface 22 of the base unit 24 so that the hypotenuse side 64 of the bracket 62 is closest to the foodstuffs carried by the heating element 60 by the conveyor 42. Heat from the heater element 60 is therefore directed rearward, i.e., toward the rear side or back of the oven's upper housing 12 and away from the viewing window 36 in the front side. The rear-ward direction of the heating element 60 away from the window 36 tends to reduce the transmission of infrared heat from the oven.

The hypotenuse side 64 of the heater support bracket 62 is shown in the figure to be inclined at the angle θ with respect to the top surface 22 of the base unit 24. The angle θ preferably corresponds to the angle formed by the “sides” or the surface of a foodstuff to be cooked or heated. In most applications, the angle θ will be greater than or equal to forty-five degrees but less than ninety degrees.

By inclining the heater element 60 to the inclination angle of a shaped food stuff, heat from the heater element 60 is directed horizontally toward foodstuffs. Inclined surfaces of a food stuff tend to be heated more evenly by an inclined heating element 60 yielding a more-evenly heated product. Put another way, if the heater element 60 was not inclined and if the axis of a cone passing in front of the heating element 60 was also not inclined, evenly heating a cone-shaped foodstuff would be problematic. If the heating element 60 were vertical and if the cone's axis was also vertical, the wide part of a cone would be too close to the heating element 60, or the narrow pointed end would be too far from the heating element to evenly heat a cone from top to bottom. Portions of a cone farther away from the heating element 60 would either be undercooked while portions of a cone close to the heating element 60 would be overcooked or over heated. By inclining or tilting the heating element 60 as shown, horizontally-directed heat from the heating element 60 enables a cone shaped foodstuff or a cone filled with foodstuffs to be heated more uniformly from top to bottom.

The embodiments described above and depicted in the accompanying figures are examples and should not be considered to be limiting. The true scope of the invention is set forth in the appurtenant claims.

What is claimed is:

1. A heating element comprised of:
a) a heat-emitting device having a longitudinal axis that extends upwardly from a horizontal plane at an angle.

2. The heat-emitting device of claim 1, wherein the angle corresponds to an angle formed by a surface of a foodstuff to be heated by the heat-emitting device.

3. The heat-emitting device of claim 1 wherein the angle is greater than or equal to forty-five degrees and less than ninety degrees.

4. The heat-emitting device of claim 1 wherein said angle is greater than or equal to sixty degrees and less than eighty degrees.

5. The heat-emitting device of claim 1 wherein said burner is a gas burner.

6. The heat-emitting device of claim 1 wherein said burner is an electric burner.

7. A heating element for cooking and heating foodstuffs having an inclined surface, the heating element comprised of:
a) a substantially rectangular heat-emitting device having a longitudinal axis that extends upwardly from a horizontal plane at a first angle, said first angle being substantially equal to an angle formed by a surface of a foodstuff with respect to the horizontal plane.

8. The heating element of claim 1 wherein the first angle is greater than or equal to forty-five degrees and less than ninety degrees.

9. The heating element of claim 1 wherein said first angle is greater than or equal to sixty degrees and less than eighty degrees.

10. The heating element of claim 1 wherein said heat-emitting device is a gas burner.

11. The heating element of claim 1 wherein said heat-emitting device is an electric burner.

12. A heating element for cooking and heating conically-shaped and pyramidal-shaped foodstuffs in an oven, the heating element comprised of:
a) a substantially concave burner having a longitudinal axis that extends upwardly from a horizontal plane at a first angle that is substantially equal to an angle formed by surface of foodstuff with respect to the horizontal plane.
